(19) United States
(12) Patent Application Publication
(10) Pub. No.: US 2015/0104591 A1
(43) Pub. Date: Apr. 16, 2015

(54) Removable adherent sheet with polyurethane adherent coating that provides air displacing adhesion properties onto various surfaces and an inkjet, laser or digital press printing receptive top coat for graphic signage and the application thereof

(71) Applicants: Andrew Lim, Fullerton, CA (US); Jong Youl Song, Gunsan City (KR)

(72) Inventors: Andrew Lim, Fullerton, CA (US); Jong Youl Song, Gunsan City (KR)

(21) Appl. No.: 14/055,595

(22) Filed: Oct. 16, 2013

(51) Int. Cl. G09F 3/10; C08G 18/06; C09D 175/04

(52) U.S. Cl. CPC G09F 3/10; C09D 175/04; C08G 18/06; G09F 2003/0241
USPC 428/32.22; 428/41.8; 524/590; 528/85; 156/60

(57) ABSTRACT

A re-adherable adherent sheet with an inkjet, laser or digital press printing receptive top coat for the purpose of removable graphic signage is provided. A polyurethane adherent layer is provided that allows for repeated, non diminishing, residue free adherence and re-adherence onto various surfaces such as glass, tile, coated metals, coated wood, and valley less plastics by displacing air out between the polyurethane adherent layer and the adhered surface.

### FIELD OF INVENTION

The present invention is a removable adherent sheet that provides multi surface adhesion properties by the air displacing polyurethane adherent coating, repeated re-adherence without any residue, and an inkjet, laser, or digital press printing receptive properties, by the printing receptive top coat for the purpose of graphic signage.

### DESCRIPTION OF PRIOR ART

Graphic signs are becoming more popular due to the availability of inkjet, laser and digital press printers. This allows users to create their own graphic signs for commercial and noncommercial use. Furthermore, adhesive backings are being used to enhance the field of graphic signs.

There is a need in the graphic sign market for a product that can be printed on, adhered and readhered onto various surfaces and provide a residue free removal.

Graphic signs with adhesive backings are used in various forms including but not limited to signs, posters, labels, advertisements, decorations, stickers.

In the field of graphic signs there are three major types of adhesives that are used: 1) Pressure Sensitive 2) Magnetic 3) Static Cling

There are two major types of Pressure sensitive adhesives:

1) Permanent 2) Removable

An adhesive sheet comprises of a material sheet, an adhesive providing method, and a release liner if needed. Permanent pressure sensitive adhesive sheet (hereinafter referred to as PPSAS) is seen used as but not limited to, price tags, labels, stickers and permanent displays. PPSAS provides high amounts of tack and serves the purpose of permanently remaining adhered onto the adhered surface. As a result, when the PPSAS is adhered to the surface, the removal and reapplication are difficult. When the PPSAS is adhered onto the surface and after a long period of adhesion, the PPSAS is able to fully bond onto the adhered surface. As a result, when the PPSAS is peeled off, the adhered surface and the PPSAS are damaged, ultimately ruining the sheet and the surface. After peeling, leftover residue caused by the adhesive remains on the adhered surface and requires work to completely remove.

Removable pressure sensitive adhesive sheet (hereinafter referred to as RPSAS) is seen used as but not limited to short-term displays, post its, removable stickers, athletic tape, EKG electrodes. RPSAS provide a low tack adherence, easy peel and temporary adherence. As a result, the RPSAS cannot support much weight and after multiple peeling and re-adhering onto the same or different surface (hereinafter referred to as transfers) will not be able to adhere well. Due to the nature of the adhesive in Magnetic sheets and Static clinging sheets, the sheets are limited to the surfaces that they can adhere to, respectively metal and glass.
1. U.S. Pat. No. 6,139,967 issued to Tozuka et al., describes a clinging sheet comprised of a base film and a clinging layer. The clinging layer comprises of a siloxane-modified polyurethane resin that can repeatedly be clung to smooth surfaces and easily peeled. The clinging layer can be used as a seal, label or sticker.

The patent does not mention a printing receptive top coating to be used for the purpose of removable graphic signage by inkjet printers, laser printers, or digital press printers.
2. U.S. Pat. No. 5,380,572 issued to Kotani et al. describes a transparent plastic film pressure sensitive adhesive label comprising of a polyethylene resin. The primary focus being in the field of automatic labeling machines.
3. WIPO Patent No. 2,001,079,372 issued to Cleary et. al. describes a large-sized repositionable sheet assembly comprising of a paper facestock, an adhesive film and a release liner, wherein said release liner is divided up by lines of weakness. The adhesive layer comprises of an ultra-removable, pressure sensitive adhesive that extends over the entire adhesive-bearing side.

The patent does not mention a printing receptive top coating to be used for the purpose of removable graphic signage by inkjet printers, laser printers, or digital press printers, or a polyurethane adherent coating to be used as the method of adherence.
4. U.S. Pat. No. 7,332,205 issued to Hannington et. al., describes an adhesive article which provides air egress. The adhesive article comprises of a facestock, and a pattern of non-adhesive material forms that are in contact with the lower surface of the adhesive layer, wherein it provides air egress. The adhesive article describes that the adhesive article can be repositioned after light application of pressure.
5. WIPO Patent No. 2,012,061,296 issued to Gerlach et al. describes a silicone modified pressure sensitive adhesive with anti-slip properties, optical clarity, self wetting and removability properties. The free radically polymerizable mixture disclosed includes, a (meth)acrylate monomer, a urethane-based or urea-based oligomer, a segmented siloxane-based copolymer, and an initiator.

The patent does not mention a printing receptive top coating to be used for the purpose of removable graphic signage by inkjet printers, laser printers, or digital press printers, or a polyurethane adherent coating to be used as the method of adherence.
6. U.S. Pat. No. 20,060,051,551 issued to Shikano et al., describes a pressure-sensitive adhesion-processed sheet that can be easily re-stuck. The adhesive layer disclosed includes having plural small valleys and plural small peaks.

### SUMMARY

The present invention is to overcome the problems listed above and provide new advantages.

The removable adherent sheet provides a sheet that can be printed on for the purpose of graphic signage and be repeatedly adhered and re-adhered onto various surfaces by displacing air out between the polyurethane adherent coating and the adhered surface, while providing a residue free removal.

The adherent sheet can adhere onto various surfaces such as glass, tile, coated wood, coated metals, and valley less plastics.

The adherent sheet requires no more than applied finger pressure to adhere onto the adhered surface.

The adherent sheet does not rely on a wetting process or an adhesive glue to adhere.

The adherent sheet comprises of (i) a material sheet with a printing receptive top coat bearing side and an adherent coating bearing side, (ii) an inkjet, laser, or digital press printing receptive top coat, (iii) an adherent layer and (iv) a silicone coated release liner.

The adherent layer comprises of a polyurethane coat coated onto the adherent coat bearing side.

The silicone coated release liner may be used to cover the exposed side of the adherent layer.

### DETAILED DESCRIPTION

An adherent sheet consists of a material sheet, a printing receptive top coat, an adherent layer and a silicone coated release liner.

The present invention will be described in detail below.

1. Material Sheet

Varying forms of the material sheet may be used in the practice of the present invention. Varying forms include polyester films, polypropylene films, polyvinyl film, synthetic papers, woven fabrics, non-woven fabrics, paper for inkjet receiving and paper for thermally transferred images.

The material sheet is used as a receiver for the printing receptive top coat and the polyurethane adherent coat.

2. Printing Receptive Top Coat

Comprising of a filler, acrylic, polyvinyl chloride, alumina, and binder, the printing receptive top coat may be applied to the topside of the material sheet (i.e. the side of the material sheet opposite the side on which the polyurethane coat is coated) for the purpose of providing printing receptive properties.

(a) Filler

Typical fillers that may be used include silica, hydrates of alumina, titania, carbonates, glass beads, micronized polyethylene wax, micronized polypropylene wax, acrylic beads, methacrylic beads, kaolin clay, a calcined clay, titanium dioxide, talc, silicate, crystalline silicas, poly(methyl methacrylate), hollow sphere polystyrene beads, micro crystalline cellulose, zinc oxide.

Preferably silica and hydrates of alumina are used. These fillers may be used either singly or used in combination of two or more. The amount of filler used is 25 to 50% by total weight of the mixture.

(b) Acrylic

An acrylic may be used in the mixture. The amount of acrylic used is 7 to 50% by total weight of the mixture.

(c) Polyvinyl Chloride

Polyvinyl chloride may be used in the mixture. The amount of polyvinyl chloride used is 5 to 65% by total weight of the mixture.

(d) Alumina

Alumina may be used in the mixture. The amount of alumina used is 5 to 35% by total weight of the mixture.

(e) Binder

Typical binders include, gelatin, methacrylates, polystyrenes, acrylamides, poly(vinyl alcohol), cellulose derivatives casein, starch, polyvinyl alcohol, carboxymethylcellulose, styrene-butadiene latex, vinyl acetate emulsion, polyvinyl alcohol, polyvinyl pyrrolidone/polyvinyl acetate copolymer, cellulose derivatives, acrylics, styrene acrylic latex, a styrene butadiene latex, a poly(vinyl alcohol), a poly(vinyl acetate). These binders may be used either singly or used in combination of two or more. The amount of binder used is 15 to 35% by total weight of the mixture.

The printing receptive top coat may be coated through conventional coating methods.

Conventional coating methods including, blade coating, gravure coating, bar coating, knife coating and extrusion melt coating. The coating thickness is 15-30 microns.

3. Adherent Layer

The adherent layer is composed of a polyurethane coating. The polyurethane coating may be applied to bottom side of the material sheet (i.e. the side of the material sheet opposite the side on which the printing receptive top coat is coated) for the purpose of providing adherent properties.

The adherent layer adheres onto various surfaces by displacing out air in-between the adherent layer and the adhered surface. Various surfaces include, glass, tile, valley less plastics, and coated metals.

The polyurethane coat is a polyurethane prepolymer mixture that is coated through conventional coating methods. The polyurethane prepolymer mixture comprises of a polyisocyanate and a polyol.

(a) Polyisocyanate

Typical polyisocyanate include 4,4′-diphenylmethane diisocyanate (MDI), hydrogenated MDI, tolylene diisocyanate (TDI), isophorone diisocyanate (IPDI). Preferably 4,4′-diphenylmethane diisocyanate (MDI), hydrogenated MDI, tolylene diisocyanate (TDI) are used. These polyisocyanates may be used singly or used in combination of two or more. The amount of polyisocyanate used in the polyurethane prepolymer mixture is 15 to 35% by total weight.

(b) Polyol

Typical high molecular weight polyol include, a polyester polyol, a polyether polyol, a polycarbonate polyol and a polylactone polyol, polyethylene glycol, a polypropylene glycol and an ethylene glycol-propylene glycol copolymer. Preferably a high molecular weight polyester polyol and polyether polyol may be used. These polyols may be used singly or used in combination. The amount of polyol used in the polyurethane prepolymer mixture is 15 to 40% by total weight of the mixture.

(c) Diol

A low molecular weight diol may be added as a chain extender. Typical low molecular weight diol include, ethylene glycol, propylene glycol, 1,4-butanediol, 1,3-butanediol, 1,6hexanediol, diethylene glycol, cyclohexanediol, isophoronediamine. Preferably 1,6 hexanediol and cyclohexanediol are to be used. These diols may be used singly or used in combination. The amount of diol used in the polyurethane prepolymer mixture is 10 to 70% by total weight of the mixture, more preferably 15 to 35% by total weight of the mixture.

The polyurethane prepolymer mixture may be coated through conventional coating methods.

Conventional coating methods including, blade coating, gravure coating, bar coating, knife coating and extrusion melt coating. The coating thickness is 15-36 microns. A preferred coat weight range is 10-40 grams/square meter.

4. Silicone Coated Release Liner

The Silicone coated release liner comprises of a paper or polyester film that is coated with silicone. The release liner may be applied to the exposed side of the adherent layer.

1. An adherent sheet comprising, a material sheet, a printing receptive top coat, an adherent layer and a silicone coated release liner.

2. Said material sheet of claim 1, comprising (a) printing receptive top coat bearing side (b) adherent coating bearing side.

3. Said adherent sheet of claim 1, is provided with the property suitable for various printer reception by the said printing receptive top coat of claim 1.
Wherein the various printer reception comprises of inkjet printer reception, laser printer reception, or digital press printer reception.

4. Said printing receptive top coat of claim 1, comprises of a top coat mixture coated onto said printing receptive top coat bearing side of claim 2.
Wherein the printing receptive top coat has a thickness of at least 15-30 microns.

5. Said top coat mixture of claim 4, comprises of (a) filler (b) acrylic (c) polyvinyl chloride (d) alumina (e) binder.
Wherein the top coat mixture comprises on the whole top coat mixture weight basis,
(a) 25 to 50% by weight of a filler
(b) 7 to 50% by weight of an acrylic
(c) 5 to 65% by weight of a polyvinyl chloride
(d) 5 to 35% by weight of an alumina
(e) 15 to 35% by weight of a binder

6. Said adherent sheet of claim 1, is provided with the property to adhere onto various surfaces by air displacing method of adherence by the said adherent layer of claim 1.

7. Said various surfaces of claim 6, comprises of glass, tile, valley less plastics, coated metals, and coated woods.

8. An adhered surface comprises of the various surfaces of claim 7, wherein the adherent layer of claim 1 is adhered onto.

9. Said air displacing method of adherence of claim 6, requires a force no more than applied finger pressure to adhere onto the adhered surface.

10. Said air displacing method of adherence of claim 6, adheres by displacing air out between the adherent layer of claim 1 and the adhered surface of claim 8.

11. Said adherent layer of claim 1, comprises of a polyurethane coat coated onto said adherent coating bearing side of claim 2.
Wherein the polyurethane coat has a thickness of at least 15-36 microns.

12. Said polyurethane coating of claim 11, comprises of a prepolymer mixture.

13. Said prepolymer mixture of claim 12, comprises of (a) polyisocyanate (b) polyol (c) diol.
Wherein the prepolymer mixture, comprises on the whole prepolymer mixture basis,
(a) 15 to 25% by weight of polyisocyanate
(b) 15 to 45% by weight of polyol
(c) 10 to 35% by weight of diol

14. Said silicone coated release liner of claim 1, comprises of a polyester film or paper.
Wherein the silicone coated release liner is placed on the exposed side of the said adherent layer of claim 1.

15. The adherent sheet in claim 1 is used in various removable display signage.
Wherein the form of removable signage is printed onto the ink receptive top coat by wide-format printers, inkjet printers, laser printers, and digital press printers.

16. The various removable display signage in claim 15, is a form of removable labels.
Wherein the form of labels comprises, label banners, identification labels, reminders, charts, price indicators, markers, size indicators, label signs, asset labeling.

17. The various removable display signage in claim 15, is a form of removable advertisement.
Wherein the form of advertisement comprises, car bumper advertisement, floor advertisement, advertisement signage, banners, window sales advertising, limited time sales, event advertising, product promotion, promotional deals, promotional gifts, stickers, labels, decals.

18. The various removable display signage in claim 15, is a form of removable home decoration.
Wherein the form of removable home decoration comprises, window stickers, visual signs, vehicle decals, stickers, refrigerator decoration, window decoration, mirror stickers, event decorations.

19. The various removable display signage in claim 15, is a form of removable educational material.
Wherein the form of educational material comprises, activity stickers, educational signs, maps, activity pieces, game pieces.
